(19) United States
(12) Patent Application Publication
(10) Pub. No.: US 2025/0293338 A1
(43) Pub. Date: Sep. 18, 2025

(54) BATTERY PACK AND METHOD OF MANUFACTURING BATTERY PACK

(71) Applicant: TOYOTA JIDOSHA KABUSHIKI KAISHA, Toyota-shi Aichi-ken (JP)

(72) Inventors: Yasumasa OGUMA, Nagoya-shi Aichi-ken (JP); Satomi YAMAMOTO, Miyoshi-shi Aichi-ken (JP); Yuzo MIURA, Toyota-shi Aichi-ken (JP); Takashi GOUDA, Toyota-shi Aichi-ken (JP); Yusuke KURUMA, Toyota-shi Aichi-ken (JP); Hiroaki YAMAMICHI, Takahama-shi Aichi-ken (JP); Haruka TSURUTA, Toyota-shi Aichi-ken (JP)

(73) Assignee: TOYOTA JIDOSHA KABUSHIKI KAISHA, Toyota-shi Aichi-ken (JP)

(21) Appl. No.: 19/076,324

(22) Filed: Mar. 11, 2025

(30) Foreign Application Priority Data
Mar. 15, 2024 (JP) 2024-040817

(51) Int. Cl. H01M 10/6551; H01M 10/658; H01M 50/209; H01M 50/244

(52) U.S. Cl. CPC H01M 10/6551; H01M 10/658; H01M 50/209; H01M 50/244

(57) ABSTRACT

A battery pack includes a plurality of battery cell arrays. Each of the plurality of battery cell row is configured by arranging a plurality of batteries in a thickness direction of the batteries. The plurality of the battery cell arrays are arranged adjacent to each other in a width direction of the batteries. A first heat conductive material is arranged adjacent to a bottom surface of each of the batteries. A heat insulator is arranged between the batteries constituting each battery cell row and oppositely to a side surface of each of the batteries in the thickness direction. A second heat conductive material is arranged adjacent to a side surface of each of the batteries in the width direction between the plurality of battery cell arrays.

### CROSS REFERENCE TO RELATED APPLICATIONS

This application is based upon and claims the benefit of priority from Japanese patent application No. 2024-040817, filed on Mar. 15, 2024, the disclosure of which is incorporated herein in its entirety by reference.

### BACKGROUND

The present disclosure relates to a battery pack and a method of manufacturing a battery pack for dissipating heat generated by batteries.

Conventionally, various techniques for dissipating heat generated by a battery such as a secondary battery have been proposed. As an example of such techniques, Patent Literature 1 discloses a battery pack including a heat insulating member for insulating heat between thin cells adjacent to each other in a first direction (Y-direction), and a heat conductive member arranged so as to be brought in common contact with a surface of each of a plurality of thin cells arranged side by side in a second direction (X-direction) whose normal direction is the first direction.
Patent Literature 1: Japanese Unexamined Patent Application Publication No. 2020-119764

### SUMMARY

However, in a battery pack disclosed in Patent Literature 1, since both the heat insulating member and the heat conductive member are arranged between adjacent batteries in the first direction (Y-direction), there is a problem that the housing efficiency of the batteries decreases.

The present disclosure provides a battery pack and a method of manufacturing a battery pack each adapted to dissipate heat generated by the batteries while suppressing a decrease in the housing efficiency of the batteries.

A battery pack according to the present disclosure include a plurality of battery cell arrays, in which:
each of the plurality of the battery cell arrays is configured by arranging a plurality of batteries in a thickness direction of the batteries;
the plurality of the battery cell arrays are arranged adjacent to each other in a width direction of the batteries;
a first heat conductive material is arranged adjacent to a bottom surface of each of the batteries;
a heat insulator is arranged between the batteries constituting each battery cell row and oppositely to a side surface of each of the batteries in the thickness direction, while no heat conductive material is arranged between the batteries constituting each battery cell row; and
a second heat conductive material is arranged adjacent to a side surface of each of the batteries in the width direction between the plurality of the battery cell arrays.

A bottom part of the second heat conductive material may be arranged adjacent to an arrangement plate on which the batteries are arranged.

Thermal conductivity of the first heat conductive material and thermal conductivity of the second heat conductive material are higher than thermal conductivity of the heat insulator.

An area of the side surfaces of the batteries in the thickness direction is larger than an area of the side surfaces of the batteries in the width direction.

A method of manufacturing a battery pack including a plurality of battery cell arrays, the method including:
arranging a heat conductive material on an arrangement plate;
arraying batteries in a thickness direction of the batteries so that a bottom surface of each of the batteries constituting the battery cell arrays is adjacent to the heat conductive material to thereby form the plurality of the battery cell arrays;
arranging a heat insulator between the batteries constituting each battery cell row and oppositely to a side surface of each of the batteries in the thickness direction; and
arranging a heat conductive material adjacent to a side surface of each of the batteries in a width direction between the plurality of the battery cell arrays.

The method comprises arranging a bottom part of the second heat conductive material adjacent to an arrangement plate on which the batteries are arranged.

According to the present disclosure, it is possible to provide a battery pack and a method of manufacturing a battery pack each adapted to dissipate heat generated by the batteries while suppressing decrease in the housing efficiency of the batteries.

The above and other objects, features and advantages of the present disclosure will become more fully understood from the detailed description given hereinbelow and the accompanying drawings.

### BRIEF DESCRIPTION OF DRAWINGS

FIG. 1 is a perspective view showing a battery pack according to the present disclosure;

FIG. 2 is a top view showing a battery pack according to the present disclosure;

FIG. 3 is a side view showing a battery pack according to the present disclosure; and

FIG. 4 is a flowchart showing a method of manufacturing a battery pack.

### DESCRIPTION OF EMBODIMENTS

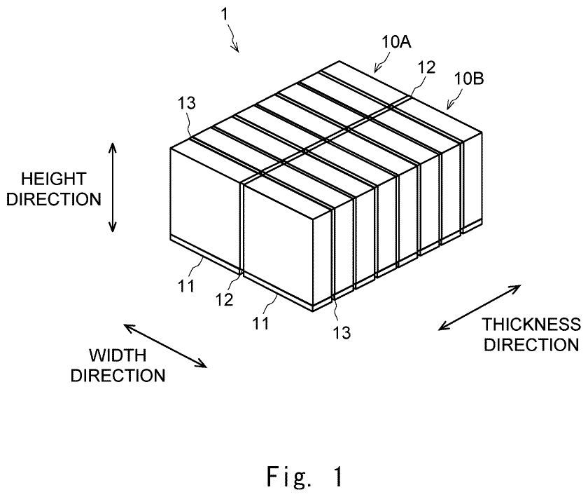

An embodiment of the present disclosure will now be described with reference to the drawings. FIG. 1 is a perspective view showing a battery pack 1 according to the present disclosure. The battery pack 1 includes battery cell arrays 10A and 10B. In FIG. 1, two battery cell arrays are shown, but the number of the battery cell arrays is not limited thereto, and the battery pack 1 may include three or more battery cell arrays.

As shown in FIG. 1, each of the battery cell arrays 10A and 10B is formed by arranging a plurality of batteries in a thickness direction of the batteries. The battery cell arrays 10A and 10B are arranged adjacent to each other in a width direction of the batteries.

The area of the side surfaces of the batteries in the thickness direction is larger than the area of the side surfaces of the batteries in the width direction. For example, the area of the side surfaces in the thickness direction may be seven times or larger than the area of the side surfaces in the width direction. The ratio of the area of the side surfaces in the thickness direction to the area of the side surfaces in the width direction is not limited to this value.

A heat insulator 13 is arranged between the batteries constituting the respective battery cell arrays 10A and 10B and oppositely to the side surfaces of the batteries in the thickness direction. For example, the heat insulator 13 may be arranged adjacent to the side surfaces of the batteries in the thickness direction. As is apparent from FIG. 1, no heat conductive material is arranged between the batteries constituting the respective battery cell arrays 10A and 10B.

Specific examples of the heat insulator 13 include a heat insulator made of resin, glass wool, an aerogel heat insulator made of silica which is an inorganic material, and the like. In some embodiments, the thermal conductivity of the heat insulator 13 is lower than that of the heat conductive material described below. For example, the thermal conductivity of a heat insulator made of resin is about 0.5 W/m·K, and the thermal conductivity of an aerogel heat insulator is about 0.03 W/m·K.

In some embodiments, the thickness of the heat insulator is such that heat generated by a battery is transferred to other batteries located in the width direction of the heat-generated battery rather than to other batteries located in the thickness direction of the heat-generated battery. For example, the thickness of the heat insulator may be such that over 50% of the heat value of the battery in a thermal runaway state is transferred to other batteries located in the width direction of the battery in a thermal runaway state.

As shown in FIG. 1, first heat conductive materials 11 are arranged adjacent to each other on the bottom surfaces of the batteries constituting the battery cell arrays 10A and 10B. The size of the first heat conductive material 11 may be the same as the size of the bottom surface of the battery that is arranged oppositely to the heat conductive material 11. The thickness of the first heat conductive material 11 may be any thickness. In the example shown in FIG. 1, a plurality of individual first heat conductive materials 11 are arranged adjacent to each other on the bottom surface of each battery, but in another embodiment, one first heat conductive material 11 may be arranged adjacent to the bottom surface of each battery.

Further, a second heat conductive material 12 is arranged between the battery cell arrays 10A and 10B adjacent to the side surfaces of the batteries in the width direction. The size of each second heat conductive material 12 may be the same as that of the side surfaces of the adjacent batteries in the width direction. The thickness of each second heat conductive material 12 may be any thickness in consideration of the heat dissipation performance and the housing efficiency.

Specific examples of the first heat conductive material 11 and the second heat conductive material 12 include a resin material or a rubber material containing an insulating ceramic. The thermal conductivity of the heat conductive material containing a resin material or a rubber material containing a ceramic is about 2-3 W/m·K. In some embodiments, the first heat conductive material 11 and the second heat conductive material 12 are higher than that of the heat insulator 13. In the case where the casing of the battery is subjected to an insulating treatment, the first heat conductive material 11 and the second heat conductive material 12 need not have any insulating properties.

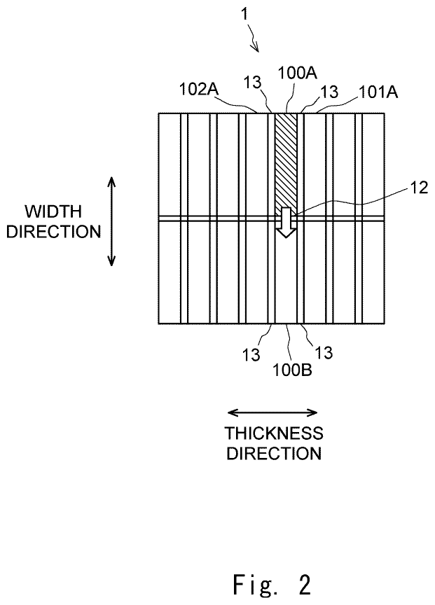

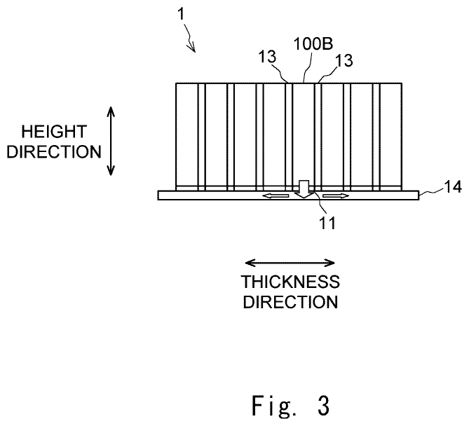

FIG. 2 is a top view showing the battery pack 1 according to the present disclosure. FIG. 3 is a side view showing the battery pack 1 according to the present disclosure. Referring to FIGS. 2 and 3, an example in which thermal runaway has occurred in the battery 100A will be described.

In the case where thermal runaway has occurred in the battery 100A, as shown in FIG. 2, due to the presence of the heat insulator 13, the heat generated by the battery 100A is transferred to the other batteries 101A and 102A located in the thickness direction of the battery 100A. In addition, due to the presence of the second heat conductive material 12, the heat generated by the battery 100A is transferred to the other battery 100B located in the width direction of the battery 100A. As shown in FIG. 3, the heat transmitted to the battery 100B is transmitted to an arrangement plate 14 via the first heat conductive material 11 arranged adjacent to the bottom surface of the battery 100B. Similarly, the heat generated by the battery 100A is transmitted to the arrangement plate 14 via the first heat conductive material 11 arranged adjacent to the bottom surface of the battery 100A.

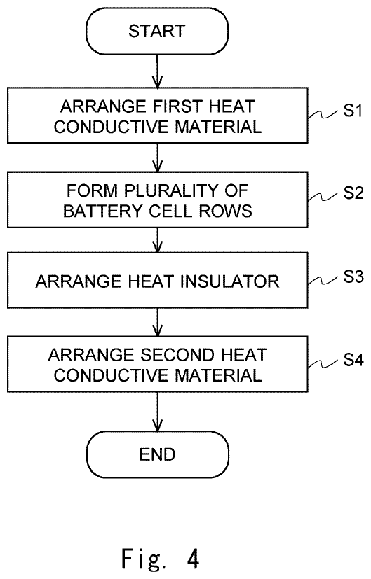

Next, a method of manufacturing the battery pack 1 will be described. FIG. 4 is a flowchart showing a method of manufacturing the battery pack 1. The method of manufacturing the battery pack 1 includes Step S1 of arranging a first heat conductive material, Step S2 of forming a plurality of battery cell arrays, Step S3 of arranging a heat insulator, and Step S4 of arranging a second heat conductive material.

In Step S1, the first heat conductive material 11 is arranged on the arrangement plate 14 of the battery. In Step S2, the batteries are arrayed in a thickness direction of the batteries so that the bottom surface of each battery constituting the battery cell row is adjacent to the first heat conductive material 11 to thereby form a plurality of battery cell arrays. In Step S3, the heat insulator 13 is arranged between the batteries constituting the respective battery cell arrays and oppositely to the side surfaces of the batteries in the thickness direction. In Step S4, the second heat conductive material 12 is arranged between the plurality of battery cell arrays adjacent to the side surfaces of the batteries in the width direction.

In the above-described embodiment, the first heat conductive material 11 is arranged adjacent to the bottom surfaces of the batteries. The heat insulator 13 is arranged between the batteries constituting the respective battery cell arrays 10A and 10B and oppositely to the side surfaces of the batteries in the thickness direction. The second heat conductive material 12 is arranged between the battery cell arrays 10A and 10B adjacent to the side surfaces of the batteries in the width direction.

By adopting this configuration, heat generated by the battery in which thermal runaway has occurred is dissipated from bottom surface of the battery in which thermal runaway has occurred via the first heat conductive material 11. Heat generated by the battery in which thermal runaway has occurred is transmitted to other batteries located in the width direction of the heat-generated battery via the second heat conductive material, and is dissipated from the bottom surfaces of the other batteries via the first heat conductive material. Further, no heat conductive material is arranged between the batteries constituting the respective battery cell arrays 10A and 10B. Therefore, heat generated by the battery can be dissipated while reducing the housing efficiency of the battery.

The present disclosure is not limited to the above-described embodiment, and can be appropriately modified without departing from the purpose. For example, in another embodiment, the bottom part of the second heat conductive material may be arranged adjacent to the arrangement plate 14. Thus, heat transmitted from the battery in a thermal runaway state to the second heat conductive material can be directly released to the arrangement plate 14.

In another embodiment, Steps S2 and S3 may be performed simultaneously. Specifically, a plurality of battery cell arrays in which the heat insulator 13 is arranged between the plurality of batteries in the thickness direction may be formed by arraying a plurality of batteries in the thickness direction of the batteries and further arranging the heat insulator 13. Alternatively, a plurality of battery cell arrays may be formed by arraying a plurality of batteries in the thickness direction of the batteries and further arranging the heat insulator 13 and the second heat conductive material 12.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A battery pack comprising a plurality of battery cell arrays, wherein:
each of the plurality of the battery cell arrays is configured by arranging a plurality of batteries in a thickness direction of the batteries;
the plurality of the battery cell arrays are arranged adjacent to each other in a width direction of the batteries;
a first heat conductive material is arranged adjacent to a bottom surface of each of the batteries;
a heat insulator is arranged between the batteries constituting each battery cell row and oppositely to a side surface of each of the batteries in the thickness direction, while no heat conductive material is arranged between the batteries constituting each battery cell row; and
a second heat conductive material is arranged adjacent to a side surface of each of the batteries in the width direction between the plurality of the battery cell arrays.

2. The battery pack according to claim 1, wherein a bottom part of the second heat conductive material is arranged adjacent to an arrangement plate on which the batteries are arranged.

3. The battery pack according to claim 1, wherein thermal conductivity of the first heat conductive material and thermal conductivity of the second heat conductive material are higher than thermal conductivity of the heat insulator.

4. The battery pack according to claim 1, wherein an area of the side surfaces of the batteries in the thickness direction is larger than an area of the side surfaces of the batteries in the width direction.

5. A method of manufacturing a battery pack including a plurality of battery cell arrays, the method comprising:
arranging a first heat conductive material on an arrangement plate;
arraying batteries in a thickness direction of the batteries so that a bottom surface of each of the batteries constituting the battery cell arrays is adjacent to the first heat conductive material to thereby form the plurality of the battery cell arrays;
arranging a heat insulator between the batteries constituting each battery cell row and oppositely to a side surface of each of the batteries in the thickness direction; and
arranging a second heat conductive material adjacent to a side surface of each of the batteries in a width direction between the plurality of the battery cell arrays.

6. The method according to claim 5, comprising arranging a bottom part of the second heat conductive material adjacent to an arrangement plate on which the batteries are arranged.

7. The method according to claim 5, wherein thermal conductivity of the first heat conductive material and thermal conductivity of the second heat conductive material are higher than thermal conductivity of the heat insulator.

8. The method according to claim 5, wherein an area of the side surfaces of the batteries in the thickness direction is larger than an area of the side surfaces of the batteries in the width direction.
